(19) United States
(12) Patent Application Publication
(10) Pub. No.: US 2014/0160819 A1
(43) Pub. Date: Jun. 12, 2014

(54) REACTOR, CONVERTER, AND POWER CONVERTER APPARATUS

(71) Applicant: Kazuhiro Inaba, Osaka-shi (JP)

(72) Inventor: Kazuhiro Inaba, Osaka-shi (JP)

(73) Assignees: Sumitomo Electric Industries, Ltd., Osaka-shi (JP); AutoNetwork Technologies, Ltd., Yokkaichi-shi (JP); Sumitomo Wiring Systems, Ltd., Yokkaichi-shi (JP)

(21) Appl. No.: 14/233,705

(22) PCT Filed: Jun. 18, 2012
(86) PCT No.: PCT/JP2012/065518

§ 371 Date: Jan. 17, 2014

(30) Foreign Application Priority Data
Jul. 20, 2011 (JP) 2011-159347

(51) Int. Cl. H01F 27/255; H02M 7/42; H02M 3/158

(52) U.S. Cl. CPC H01F 27/255; H02M 3/1582; H02M 7/42
USPC 363/123; 336/212; 323/311

(57) ABSTRACT

A reactor 1A of the present invention includes a sleeve-like coil 2, a magnetic core 3A having an inner core portion 31 disposed inside the coil 2 and an outer core portion 32A disposed outside the coil 2 to form a closed magnetic path with the inner core portion 31. The outer core portion 32A is a mold product (a hardened mold product) of a mixture of magnetic powder and resin, and structured by a combination of two radially divided pieces 321 and 322 that can be separated in the radial direction of the coil 2. Since the outer core portion 32A is structured by a plurality of divided pieces, the manufacturing time per divided piece can be shortened and excellent productivity of the reactor 1A is exhibited. When the hardened mold product is formed by injection molding, further excellent productivity is exhibited. Since the seam portion of the radially divided pieces 321 and 322 does not break the magnetic flux, no gaps that divide the magnetic flux occur between the divided pieces 321 and 322. Accordingly, the reactor 1A also has an excellent magnetic characteristic.

### TECHNICAL FIELD

The present invention relates to a reactor used as a constituent component of a power converter apparatus such as an in-vehicle DC-DC converter, a converter including the reactor, and a power converter apparatus including the converter. In particular, the present invention relates to a reactor with excellent productivity.

### BACKGROUND ART

A reactor is one of the components of a circuit that performs a voltage step up or step down operation. For example, Patent Literatures 1 and 2 disclose a reactor that is used for a converter mounted on a vehicle such as a hybrid vehicle. The reactor includes one sleeve-like coil and a magnetic core. The magnetic core is a so-called pot-type core, which includes an inner portion disposed inside the coil, and an outer portion that substantially entirely covers the opposite end faces and outer circumferential face of the coil, to form a closed magnetic path with the inner portion. Further, Patent Literatures 1 and 2 disclose, as the constituent material of the outer portion, a hardened mold product that is obtained by subjecting mixture fluid of magnetic powder and resin with flowability to molding process, and thereafter allowing the resin to cure.

### CITATION LIST

### Patent Literatures

Patent Literature 1: Japanese Patent No. 4692768
Patent Literature 2: Japanese Unexamined Patent Publication No. 2009-033051

### SUMMARY OF INVENTION

### Technical Problem

It is desired to enhance productivity of the reactor.

As described in Patent Literature 1, employing a method of manufacturing a hardened mold product by pouring the mixture fluid into a mold assembly, i.e., a so-called cast molding method, a hardened mold product of any shape can be molded with ease. However, with this mode, since the magnetic core disposed inside and outside the coil is one integrated element, it takes time to pour the raw material into the mold assembly, and also to allow the mixture to cure. Hence, productivity is poor.

As described in Patent Literature 2, employing the structure in which a magnetic core is made of an integrally combined plurality of divided pieces, as compared to the situation where the magnetic core is one integrated element, the divided pieces can each be reduced in size. Furthermore, a plurality of divided pieces can be manufactured simultaneously. Accordingly, the molding time and the curing time and the like can be shortened, and hence productivity can be increased. However, as described in Patent Literature 2, in the mode where the divided pieces can be separated in the axial direction of the coil, and where the seam portion of the divided pieces is disposed perpendicularly to the axis of the coil, an inevitable clearance is produced between the divided pieces. The clearance is present in a manner whereby the magnetic flux is broken. Therefore, with this mode, it can be understood that an inevitable gap is interposed. Accordingly, this mode may invite a reduction in the magnetic characteristic, such as generation of a leakage flux.

Accordingly, an object of the present invention is to provide a reactor with excellent productivity. Further, another object of the present invention is to provide a converter including the reactor, and a power converter apparatus including the converter.

### Solution to Problem

In the present invention, in the magnetic core, the portion disposed outside the coil is structured by a combination of a plurality of divided pieces each being a hardened mold product, and the dividing direction is set to a particular direction. Thus, the objects stated above are achieved.

The present invention provides a reactor including: a sleeve-like coil; and a magnetic core that has an inner core portion disposed inside the coil and an outer core portion disposed outside the coil, the outer core portion forming a closed magnetic path with the inner core portion. The outer core portion is structured by a combination of a plurality of divided pieces each being a mold product of a mixture of magnetic powder and resin. The outer core portion includes at least two radially divided pieces that can be separated in a radial direction of the coil.

The “radial direction of the coil” refers to the direction of any straight line that passes the center of the end face of the coil (the point on the axis of the coil). Further, the “outside the coil” refers to at least one of the end face side of the coil and the outer circumferential face side of the coil.

With the reactor of the present invention, since the outer core portion is made of a combination of a plurality of divided pieces each being a mold product of the mixture (a hardened mold product), as compared to the situation where the magnetic core is formed as one integrated element, the manufacturing time of the magnetic core can be shortened, and excellent productivity is exhibited. In particular, employing a manufacturing method according to which the mixture can be packed at high speeds in the mold assembly, such as injection molding, a further reduction in the manufacturing time can be achieved, and hence productivity can be further improved.

Further, in a mode where the inner circumferential shape of each divided piece fits to the outer shape of the coil, positioning of the coil and the magnetic core can be easily performed, and excellent assemblability is achieved. Since the divided pieces structuring the outer core portion are each a hardened mold product, the divided pieces each having the inner circumferential shape conforming to the outer shape of the coil can be molded. Thanks to this point also, the reactor of the present invention achieves excellent productivity.

Further, since the reactor of the present invention includes the radially divided pieces, any gaps breaking the magnetic flux can be reduced, or any gaps that break the magnetic flux substantially do not exist. Accordingly, the reactor of the present invention also exhibits an excellent magnetic characteristic.

As one mode of the reactor of the present invention, the magnetic powder should satisfy the following (1) to (3):

(1) the average particle size is 1 μm or more and 200 μm or less;

(2) the circularity is 1.0 or more and 2.0 or less; and

(3) the content of the magnetic powder in each divided piece is 30% by volume or more and 70% by volume or less.

In the foregoing mode, the magnetic powder in each divided piece has particular shape and size, and the content of the magnetic powder falls within a particular range. Such a divided piece can be manufactured by using magnetic powder that satisfies the specific shape and size as the raw material powder, and adjusting resin or the like such that the content of the magnetic powder falls within the aforementioned particular range. Using such specific magnetic powder as the raw material powder, and setting the blending amount of the magnetic powder to fall within a particular range, in manufacturing each divided piece, the raw material can be fully packed in the mold assembly when a molding method in which a raw material is packed in a mold assembly under pressure, such as injection molding, transfer molding, MIM (Metal Injection Molding) and the like, and a press molding method in which a raw material is packed in a mold assembly and molded under pressure. Thus, a divided piece with excellent molding precision can be manufactured. Further, since the molding method achieving excellent mass productivity can be suitably used, mass production can be also achieved with the mode described above.

As one aspect of the present invention, the sleeve-like coil is included by one in number, and at least one of the radially divided pieces includes portions that respectively partially cover end faces of the coil, and a portion that partially covers an outer circumferential face of the coil.

With the mode described above, a reduction in size can be achieved easier as compared to the mode in which a pair of coil elements is included (FIG. 7 of Patent Literature 1), and the mode described above is preferable for uses such as an in-vehicle component with which a reduction in size and weight is desired. Further, since at least one radially divided piece includes the particular portion that extends from one end face of the coil to cover other end face of the coil via the outer circumferential face of the coil, that is, the portion having a Π-shaped cross section, the divided piece does not break the magnetic flux formed by the coil midway, but allows the magnetic flux to pass from the one end face side of the coil to the other end face side via the outer circumferential face side of the coil. Accordingly, with the mode described above, an excellent magnetic characteristic is obtained.

As one aspect of the present invention, the divided pieces respectively have engaging portions that engage with each other.

In the mode described above, the divided pieces can be easily positioned relative to each other, and excellent assemblability is achieved.

The reactor of the present invention can be suitably used as a constituent component of a converter. A converter of the present invention includes: a switching element; a driver circuit that controls an operation of the switching element; and a reactor that smoothes a switching operation, wherein the converter converts an input voltage by the operation of the switching element, and the reactor is the reactor of the present invention. The converter of the present invention can be suitably used as a constituent component of a power converter apparatus. A power converter apparatus of the present invention includes: a converter that converts an input voltage; and an inverter that is connected to the converter and that performs interconversion between a direct current and an alternating current, wherein the power converter apparatus drives a load by power obtained by conversion of the inverter, and the converter is the converter of the present invention.

Since the converter of the present invention and the power converter apparatus of the present invention include the reactor of the present invention, excellent productivity is exhibited.

### Advantageous Effects of Invention

The reactor of the present invention exhibits excellent productivity. Since the converter of the present invention and the power converter apparatus of the present invention include the reactor of the present invention with excellent productivity, they exhibit excellent productivity.

### BRIEF DESCRIPTION OF DRAWINGS

FIG. 1 (A) is a schematic perspective view of a reactor according to a first embodiment; FIG. 1 (B) is a cross-sectional view taken along line (B)-(B) shown in FIG. 1 (A); and FIG. 1 (C) is a cross-sectional view taken along line (C)-(C) shown in FIG. 1 (A).

FIG. 2 is an exploded perspective view of the reactor according to the first embodiment.

FIG. 3 is a schematic perspective view showing the state of the reactor according to first embodiment stored in a case.

FIG. 4 is a schematic perspective view of a reactor according to a second embodiment.

FIG. 5 is an exploded perspective view of the reactor according to the second embodiment.

FIG. 6 is a schematic perspective view showing the state where part of an outer core portion is assembled to a coil mold product included in the reactor according to the second embodiment.

FIG. 7 is a schematic perspective view of a reactor according to a third embodiment.

FIG. 8 is an exploded perspective view of the reactor according to the third embodiment.

FIG. 9 is a schematic configuration diagram schematically showing a power supply system of a hybrid vehicle.

FIG. 10 is a schematic circuit diagram showing one example of a power converter apparatus of the present invention including the converter of the present invention.

### DESCRIPTION OF EMBODIMENTS

In the following, a specific description will be given of embodiments of the present invention with reference to the drawings. Throughout the drawings, identical reference signs denote identically named elements.

### First Embodiment

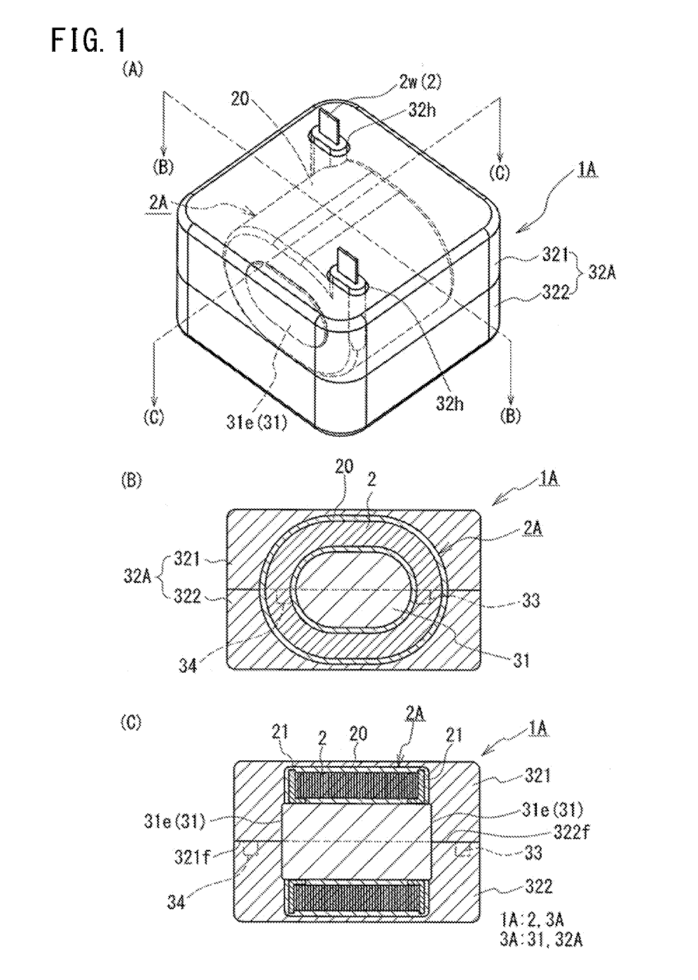

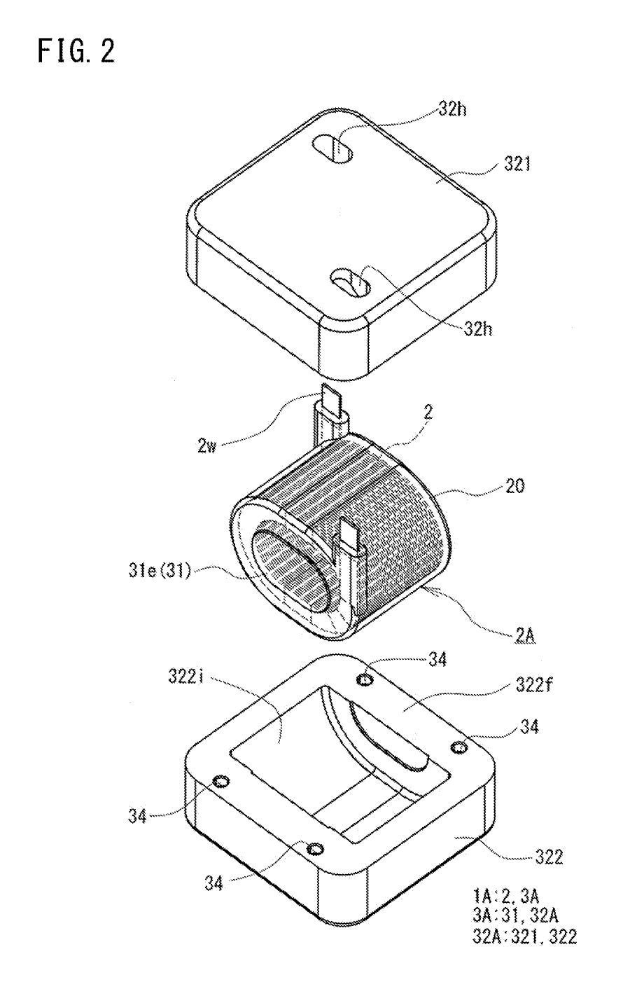

With reference to FIGS. 1 and 2, a description will be given of a reactor 1A according to a first embodiment. The reactor 1A is representatively used as a circuit component as being installed on an installation target, such as a cooling table that is made of metal (representatively, made of aluminum) and that includes a circulation path (not shown) of coolant. The reactor 1A includes one sleeve-like coil 2 made of a wound wire 2w, a magnetic core 3A disposed inside and outside the coil 2 to form a closed magnetic path. The magnetic core 3A includes an inner core portion 31 disposed inside the coil 2 and an outer core portion 32A disposed outside the coil 2. The reactor 1A is characterized by the shape and material of the outer core portion 32A. In the following, a detailed description will be given of structures.

[Coil Mold Product]

The reactor 1A includes a coil mold product 2A. The coil mold product 2A includes a resin mold portion 20 made of an insulating resin that retains the shape of the coil 2 and that integrally retains the coil 2 and the inner core portion 31. When the coil mold product 2A is assembled to the outer core portion 32A, the coil 2 is not expanded or compressed and thus excellent handleability is obtained. Further, herein, the coil 2 and the inner core portion 31 are integrated by the resin mold portion 20. Therefore, in connection with the coil mold product 2A, the coil 2 and the inner core portion 31 can be handled as one component. Accordingly, with the reactor 1A, a reduction in the number of components and the steps in assembling, and an improvement in assemblability can be achieved. Further, since the resin mold portion 20 is included, insulation between the coil 2 and the magnetic core 3A can also be enhanced.

<Coil>

The coil 2 is a sleeve-like element, which is made of one continuous wire 2w being spirally wound. As the wire 2w, a coated wire including a conductor made of a conductive material such as copper, aluminum, or alloy thereof may be preferably used. The conductor is provided with an insulating coat made of an insulating material at its outer circumference. The conductor may be of a variety of shape, such as a rectangular wire whose cross-sectional shape is rectangular, a round wire whose cross-sectional shape is circular, or a deformed wire whose cross-sectional shape is polygonal, elliptical or the like. The thickness (cross-sectional area) or the number of turns or the like of the wire 2w can be selected as appropriate.

The end face shape of the coil 2 may be, for example, the shape whose contour is a curve (the outer circumferential face of the coil 2 is made of a curved surface) such as a ring-like shape or an elliptical ring-like shape (the center in the end face is the center of the ellipse), the shape whose contour is a combination of curves and straight lines (the outer circumferential face of the coil 2 is a curved surface and a flat surface) such as a rounded shape being a rounded quadrangular frame (the center in the end face is the intersection of diagonal lines), a racetrack shape made of a combination of semicircles and straight lines (the center in the end face is the intersection of the diagonal lines in a quadrangle formed by arcs of the semicircles and the straight lines). When at least part of the outer circumferential face of the coil 2 is a curved surface, the wire 2w can be wound around easier and hence excellent manufacturability of the coil is achieved. When part of the outer circumferential face of the coil 2 is made of a flat surface, arranging the flat surface to be the face disposed on the installation target side, or the face to be in contact with the installation target, the area opposing to the installation target can be increased easier, and the heat dissipating characteristic can be enhanced or stability of the installation state can be enhanced.

Herein, the coil 2 is an edgewise coil formed by a coated rectangular wire wound edgewise. The coated rectangular wire includes a rectangular wire made of copper whose cross-sectional shape is rectangular and which is provided with an insulating coat made of enamel (representatively, polyamide-imide). Further, the end face shape of the coil 2 (which is equivalent to the cross-sectional shape of the coil 2 taken along a plane being perpendicular to the axial direction (FIG. 1 (B))) is a racetrack shape. Further, the coil 2 is disposed such that its axial direction is parallel to the surface of the installation target when the reactor 1A is installed on the installation target (hereinafter, this disposition is referred to as the horizontal disposition).

The wire 2w forming the coil 2 has drawn out portions that are drawn out as appropriate from the turn forming portion. As shown in FIG. 1 (A), the opposite end portions of the wire 2w are drawn out to the outside of the outer core portion 32A, each having the insulating coat stripped off therefrom. To the exposed conductor portion, a terminal member (not shown) made of a conductive material such as copper or aluminum is connected using welding such as TIG welding, fixation under pressure or the like. Via the terminal member, an external apparatus (not shown) such as a power supply that supplies power to the coil 2 is connected. In the example shown in FIG. 1, though the opposite end portions of the wire 2w are drawn out perpendicularly to the axial direction of the coil 2, the draw-out direction of the opposite end portions can be selected as appropriate. For example, the opposite end portions of the wire 2w can be drawn out in parallel to the axial direction of the coil 2. Alternatively, the draw-out direction or the position in the axial direction of the coil may be different between the opposite end portions.

<Resin Mold Portion>

As the resin structuring the resin mold portion 20, what is preferably used is an insulating material that has the heat resistance with which the resin does not soften when the maximum temperature of the coil 2 or the magnetic core 3A is reached during operation of the reactor 1A, and that can be subjected to transfer molding or injection molding. The exemplary resin may be thermosetting resin such as epoxy resin, or thermoplastic resin such as polyphenylene sulfide (PPS) resin and liquid crystal polymer (LCP). Herein, epoxy resin is used. As the resin structuring the resin mold portion 20, employing the resin containing a filler made of at least one type of ceramic selected from silicon nitride, alumina, aluminum nitride, boron nitride, and silicon carbide, a reactor with an excellent heat dissipating characteristic can be obtained.

The thickness of the resin mold portion 20 can be selected as appropriate so as to satisfy the desired insulating characteristic, e.g., approximately 0.1 mm to 10 mm. As the resin mold portion 20 is thinner, the heat dissipating characteristic can be improved (preferably 0.1 mm to 3 mm), and as it is thicker, the insulating performance and strength of the coil mold product 2A can be improved. Herein, as shown in FIGS. 1 (B) and 1 (C), the thickness is substantially uniform.

Herein, as shown in FIG. 2, since the resin mold portion 20 covers the entire outer surface of the coil 2 except for the opposite end portions of the wire 2w, insulation between the drawn out portions and the outer core portion 32A can be also secured. On the other hand, when the drawn out portions including the opposite end portions of the wire 2w are exposed outside the resin mold portion, the outer shape of the resin mold portion is simplified and hence the coil mold product can be molded easier. Furthermore, the coil mold product can be reduced in size easier. In this mode, in connection with any part in the drawn out portions of the wire 2w that may possibly be brought into contact with the magnetic core 3A (the outer core portion 32A), disposing an insulating member such as an insulating paper, an insulating tape (e.g., a polyimide tape), an insulating film (e.g., a polyimide film) to such a part, subjecting the part to dip coating of an insulating member, or covering the part by an insulating tubing (a heat shrink tubing, a cold shrink tubing or the like), insulation between the drawn out portions and the outer core portion 32A can be secured. It is also possible to cover at least one of the end faces 31e of the inner core portion 31 by the resin mold portion 20.

Providing the resin mold portion 20 with a function of retaining the coil 2 in the compressed state relative to its free length, the axial direction length of the coil 2 can be shortened, and the coil mold product 2A can be reduced in size.

The reactor 1A further includes bobbins 21 (FIG. 1(C)). The bobbins 21 are each an annular member having an L-shaped cross section including a short sleeve-like element disposed at the outer circumference of the inner core portion 31, and a plurality of flat plate-like flange portions projecting outward from the periphery of the sleeve-like element. The bobbins 21 are structured by an insulating resin such as PPS resin, LCP, polytetrafluoroethylene (PTFE) resin, and function, with the resin mold portion 20, as the insulating members for enhancing insulation between the coil 2 and the inner core portion 31. Further, the bobbins 21 function as the positioning members for the inner core portion 31 with reference to the coil 2, and the retaining members of the coil 2. Herein, two bobbins 21 are prepared, and as shown in FIG. 1 (C), the bobbins 21 are respectively disposed near the end faces 31e of the inner core portion 31, and the flange portions of each bobbin 21 abut on the end face of the coil 2.

<Manufacturing Method>

The coil mold product 2A including the inner core portion 31 can be manufactured according to, for example, the manufacturing method described in Japanese Unexamined Patent Publication No. 2009-218293 (note that the core should be replaced by the inner core portion 31). Specifically, a mold assembly that can be opened and closed, and that includes a holding rod integrally provided inside the mold assembly or a plurality of pressing rods capable of advancing and retracting relative to the mold assembly is prepared. After disposing the coil 2 and the inner core portion 31 in the mold assembly, the flange portions of the bobbins 21 are held by the holding rod, or the flange portions are pressed by the pressing rods to thereby compress the coil 2. In this state, resin is poured into the mold assembly and allowed to solidify. Since the reactor 1A includes the bobbins 21, the coil 2 and the inner core portion 31 can be stored in the mold assembly in the state where a prescribed interval (the interval corresponding to the thickness of the sleeve-like elements of the bobbins 21) is secured between the coil 2 and the inner core portion 31, and the interval can be retained. Thus, the resin mold portion 20 can be manufactured to have a uniform thickness with ease, and excellent manufacturability of the coil mold product 2A is exhibited.

Note that, the coil mold product can be structured such that the inner core portion 31 can be separated, i.e., the coil mold product may be structured by the coil and the resin mold portion. This coil mold product has a hollow hole formed by the resin structuring the resin mold portion, and the inner core portion is inserted and disposed into the hollow hole. This coil mold product can be manufactured by disposing a core of a prescribed shape in the mold assembly, in place of the inner core portion.

[Magnetic Core]

As shown in FIG. 1, the magnetic core 3A includes the columnar inner core portion 31 inserted into the coil 2, and the outer core portion 32A provided to cover the outer circumferential face and the end faces of the coil mold product 2A (the end faces 31e of the inner core portion 31 and the end faces of the resin mold portion 20), and forms a closed magnetic path when the coil 2 is excited. The outer core portion 32A is best characterized in that it is integrally formed by a combination of a plurality of divided pieces each being a mold product (a hardened mold product) of a mixture of magnetic powder and resin, and it includes radially divided pieces 321 and 322 whose dividing direction is the radial direction of the coil 2.

<Inner Core Portion>

The inner core portion 31 is a columnar element whose outer shape is a racetrack shape conforming to the inner circumferential shape of the coil 2. Herein, the inner core portion 31 is inserted and disposed into the coil 2, and the opposite end faces 31e and the area nearby respectively slightly project from the end faces of the resin mold portion 20 of the coil mold product 2A. In this state, the inner core portion 31 is retained integrally with the coil 2 by the resin structuring the resin mold portion 20.

Similarly to the outer core portion 32A, the inner core portion 31 may be a hardened mold product. Here, the component of the inner core portion 31 may be identical to or different from that of the outer core portion 32A. Alternatively, the inner core portion 31 may be structured by a constituent material totally different from that of the outer core portion 32A. By being structured by different materials, the magnetic characteristic of the magnetic core 3A can be partially varied. Herein, the inner core portion 31 is structured entirely by a powder magnetic core, and higher in saturation magnetic flux density than the outer core portion 32A. The outer core portion 32A is lower in permeability than the inner core portion 31.

Representatively, the powder magnetic core is obtained by molding soft magnetic powder provided with an insulating coating on its surface or mixed powder, which is a mixture of the soft magnetic powder and a binder being appropriately added; and thereafter baking the soft magnetic powder or the mixed powder at the temperature equal to or lower than the heat resistant temperature of the insulating coating. Herein, the soft magnetic powder provided with an insulating coat is used.

The soft magnetic powder may be iron group metal such as Fe, Co, Ni, Fe-base alloy powder whose main component is Fe such as Fe—Si, Fe—Ni, Fe—Al, Fe—Co, Fe—Cr, and Fe—Si—Al, rare-earth metal powder, ferrite powder and the like. In particular, with the iron base material, a magnetic core with a high saturation magnetic flux density can be obtained easier than with ferrite. The insulating coating formed at the soft magnetic powder may be, for example, a phosphate compound, a silicon compound, a zirconium compound, an aluminum compound, or a boron compound. When the insulating coat is provided particularly when the magnetic particles structuring the magnetic powder is made of metal such as iron group metal or Fe-base alloy, the eddy current loss can be effectively reduced. The binder may be, for example, thermoplastic resin, non-thermoplastic resin, or higher fatty acid. The binder may be vanished by the baking, or may change into an insulating substance such as silica. The powder magnetic core in which an insulating substance such as the insulating coating is present among the magnetic particles can reduce the eddy current thanks to insulation among the magnetic particles, even when the coil is energized with high-frequency power, and thus a loss can be reduced. Any known powder magnetic core can be used. Using the soft magnetic powder of a high saturation magnetic flux density, increasing the proportion of the soft magnetic material by reducing the blending amount of the binder, or increasing the molding pressure, a powder magnetic core with a high saturation magnetic flux density can be obtained.

Herein, the saturation magnetic flux density of the inner core portion 31 is 1.6 T or more and 1.2 times as great as the saturation magnetic flux density of the outer core portion 32A or greater; the relative permeability of the inner core portion 31 is 100 to 500; and the relative permeability of the whole magnetic core 3A is 10 to 100. The saturation magnetic flux density of the inner core portion 31 is preferably 1.8 T or more, and further preferably 2 T or more. Preferably, the saturation magnetic flux density of the inner core portion 31 is 1.5 times, and further preferably 1.8 times, as great as the saturation magnetic flux density of the outer core portion 32A or greater. Using the lamination product of electromagnetic steel sheets as being represented by silicon steel plates in place of the powder magnetic core, the saturation magnetic flux density of the inner core portion can be increased further easier.

Further, herein, the inner core portion 31 is a solid element with no gap member or air gap being interposed. It is also possible that a gap member made of a non-magnetic material such as an alumina plate or an air gap is interposed.

The axial direction length of the coil 2 in the inner core portion 31 (hereinafter simply referred to as the length) and the projection length projecting from the end face of the coil 2 can be selected as appropriate. Herein, the end faces 31e of the inner core portion 31 respectively project from the end faces of the coil 2, and the projection length is identical between the end faces 31e (the length of the inner core portion 31>the length of the coil 2). On the other hand, when the end faces 31e of the inner core portion 31 and the end faces of the coil 2 are flush (the length of the inner core portion 31=the length of the coil 2), or when one end face of the inner core portion 31 is flush with one end face of the coil 2 and other end face of the inner core portion 31 projects from other end face of the coil 2 (the length of the inner core portion 31>the length of the coil 2, i.e., the projection length is different), a low-loss characteristic can be achieved. In any of the foregoing modes, the outer core portion 32A is included such that a closed magnetic path is formed when the coil 2 is excited.

As described above, since the reactor 1A is in the horizontal disposition, when the reactor 1A is fixed to the installation target, the inner core portion 31 is disposed such that its axial direction is also parallel to the surface of the installation target.

<Outer Core Portion>

The outer core portion 32A is made by a combination of two radially divided pieces 321 and 322 that can be separated in the radial direction of the coil 2. The coil mold product 2A is contained in the divided pieces 321 and 322. That is, the outer core portion 32A is disposed on both the end face sides and outer circumferential face side of the coil 2. Further, the divided pieces 321 and 322 are each a hardened mold product. Firstly, the shape is described.

Herein, the radially divided pieces 321 and 322 are solids whose outer shape becomes a rectangular parallelepiped-shape as shown in FIG. 1 (A) when combined with each other. The outer core portion 32A may be in any shape so long as a closed magnetic path is formed. It may be in the shape similar to the outer shape of the coil 2. Alternatively, part of the coil 2 (herein the coil mold product 2A) may be exposed.

Further, herein, the radially divided pieces 321 and 322 are halved pieces obtained by cutting the rectangular parallelepiped-shaped outer core portion 32A along a plane passing through the axis of the coil 2. The divided pieces 321 and 322 are each a bottomed square sleeve-like element, whose horizontal cross section taken along a plane being perpendicular to the axial direction of the coil 2 as shown in FIG. 1 (B) and whose vertical cross section taken along a plane being parallel to the axial direction of the coil 2 as shown in FIG. 1 (C) are both Π-shaped. When the reactor 1A is installed on the installation target, the bottom faces of the divided pieces 321 and 322 are disposed in parallel to the surface of the installation target. The bottom face of one radially divided piece 322 becomes the contact face relative to the installation target, and solely the divided piece 322 is brought into contact with the installation target. The divided pieces 321 and 322 separate in the direction perpendicular to the surface of the installation target.

As shown in FIG. 2 (in FIG. 2, only the inner circumferential face 322i of one radially divided piece 322 is shown), the inner circumferential face of each of the radially divided pieces 321 and 322 is molded into a shape conforming to the outer shape of the coil mold product 2A to be stored. Accordingly, the inner circumferential face of each of the divided pieces 321 and 322 is structured by the face to be brought into contact with part of the outer circumferential face (herein, half the circumference) of the coil mold product 2A and the face to be brought into contact with part (herein, half) of the end faces of the coil mold product 2A (herein, the end faces 3 le of the inner core portion 31 and the end faces of the resin mold portion 20). With the coil mold product 2A, since the inner core portion 31 projects further than the end faces of the resin mold portion 20, the inner circumferential face of each of the divided pieces 321 and 322 is in a concave-convex shape, such that the projecting inner core portion 31 is fitted thereto. In this manner, the divided pieces 321 and 322 each include a portion covering part of the outer circumferential face of the coil mold product 2A and part of the end faces of the coil mold product 2A.

The thickness of the radially divided pieces 321 and 322 can be selected as appropriate so long as a prescribed magnetic path area is secured. Herein, as shown in FIG. 1 (B), the thickness of the portions of the outer circumferential face of the coil 2 structured by flat surfaces, that is, the portion covering the portion on the installation target side when the reactor 1A is installed on the installation target and the portion on the side opposite thereto is smaller than the thickness of the portions covering the portions of the outer circumferential face of the coil 2 structured by curved surfaces. Accordingly, when the reactor 1A is installed on the installation target, as shown in FIGS. 1 (B) and 1 (C), the coil 2 is disposed in close proximity to the installation target and the distance between the coil 2 and the installation target is short. Accordingly, the reactor 1A can easily transfer the heat of the coil 2 to the installation target, and thus has an excellent heat dissipating characteristic.

Opposing faces 321f and 322f being in contact with each other in the radially divided pieces 321 and 322 are flat surfaces. Since the opposing faces 321f and 322f are flat surfaces, the divided pieces 321 and 322 are each in a simple shape and hence easily molded. Further, since the opposing faces 321f and 322f are flat surfaces, the seam portion of the divided pieces 321 and 322 is formed as a straight line as shown in FIG. 1 (A). When the reactor 1A is installed on the installation target, the seam portion is disposed in parallel to the surface of the installation target. In particular, since the straight line forming the seam portion is parallel to the straight line being present on the plane passing through the axis of the coil 2 (the straight line being parallel to the axial direction of the coil 2, and the straight line in the radial direction of the coil 2), the seam portion is disposed so as not to substantially break the magnetic flux created by the coil 2.

Further, the radially divided pieces 321 and 322 shown in this example include engaging portions (engaging projections 33 and engaging holes 34) engaging with each other. Specifically, one radially divided piece 321 includes the engaging projections 33 projecting from the opposing face 321f, and other radially divided piece 322 includes the engaging holes 34 at the opposing face 322f. When the divided pieces 321 and 322 are combined with each other, the engaging projections 33 fit into the engaging holes 34, and the divided pieces 321 and 322 can be properly combined at a prescribed position. Herein, the engaging projections 33 are formed as circular cylindrical elements and the engaging holes 34 are formed as circular holes as shown in FIG. 2, such that a plurality of engaging portions (at four places) are provided. However, one engaging portion solely may be provided. Further, the shape can be changed as appropriate also, to be prism elements, quadrangular holes and the like. Alternatively, the opposing faces of the divided pieces 321 and 322 may each be formed in a concave-convex shape such as a wavy shape or a zigzag shape, so that part of the seam portion of the divided pieces 321 and 322 becomes curvy or zigzag. Then, this concave-convex shape portion can be used as the engaging portion.

One radially divided piece 321 is provided with wire holes 32h into which the end portions of the wire 2w of the coil 2 are inserted. The shape and size of the wire holes 32h are adjusted such that the end portions of the wire 2w can be inserted at the portions corresponding to the disposition positions of the end portions of the wire 2w at the radially divided piece 321.

Next, a description will be given of the material. As a method for manufacturing the hardened mold product, injection molding, transfer molding, MIM, cast molding, press molding using magnetic substance powder and solid resin powder or the like can be employed. With the injection molding, a mixture of powder of a magnetic substance material, i.e., magnetic powder, and resin is packed in a mold assembly under a prescribed pressure to be molded, and thereafter the resin is cured. With the transfer molding and the MIM also, a raw material is packed in a mold assembly under a prescribed pressure and molded. With the cast molding, after a mixture of magnetic powder and resin is obtained, the mixture is poured into a mold assembly with no application of pressure, and molded and cured. Since the raw material mixture can be quickly packed in the mold assembly with application of a prescribed pressure with the injection molding, the transfer molding, and the MIM, those methods exhibit excellent productivity, and can be suitably used particularly for mass production. The wire holes 32h can be formed by providing hole-use projections to the mold assembly or by subjecting the hardened mold product to cutting work.

In any of the foregoing molding schemes, as the magnetic powder, the magnetic powder similar to the soft magnetic powder used for the inner core portion 31 described above can be used. In particular, for the soft magnetic powder used for the outer core portion 32A, iron base material such as pure iron powder or Fe-base alloy powder can be suitably used. It is also possible to use a plurality of types of magnetic powder of different materials as being mixed. Further, coated powder made of metal-made magnetic particles whose surface is provided with an insulating coating made of phosphate or the like can be used. In this situation, an eddy current loss can be reduced. As the magnetic powder, the powder whose average particle size is 1 μm or more and 1000 μm or less, or further, 1 μm or more and 200 μm or less can be conveniently used. A plurality of types of powder being different in particle size can be used. In this situation, a reactor with a high saturation magnetic flux density and low loss can be obtained easier.

Further, in any of the foregoing molding schemes, thermosetting resin such as epoxy resin, phenolic resin, silicone resin, urethane resin, and unsaturated polyester, and thermoplastic resin such as PPS resin and polyimide resin can be used as the resin serving as a binder. With epoxy resin, a divided piece with excellent strength can be obtained. With silicone resin, thanks to its softness, the divided piece can be joined to each other easier. When thermosetting resin is used, the mold product is heated such that the resin is thermally cured. When the thermoplastic resin is used, it is solidified at appropriate temperatures. Room temperature curing resin or low temperature curing resin can be used as the resin serving as a binder. In this situation, resin is cured by leaving the mold product at temperatures ranging from room temperatures to relatively low temperatures. As to the hardened mold product, by increasing resin being a non-magnetic material, a core being lower in saturation magnetic flux density and permeability than the powder magnetic core can be easily formed, even when the identical soft magnetic powder used for the powder magnetic core structuring the inner core portion 31 is used.

The hardened mold product may be a mixture of the magnetic powder and the resin serving as a binder, to which a filler made of ceramic such as alumina, silica, calcium carbonate, and glass fibers is added. In this mode, for example, the resin composite such as BMC in which calcium carbonate or glass fibers are mixed into unsaturated polyester can be used as the raw material. Since the BMC has excellent injection moldability, it can contribute toward improving productivity. By mixing the filler of smaller specific gravity as compared to the magnetic powder, the magnetic powder can be suppressed from being unevenly located, and a mold product in which magnetic powder is evenly dispersed can be obtained. Further, when the filler is made of the material with excellent thermal conductivity, it can contribute toward improving the heat dissipating characteristic. Further, since the filler is contained, an improvement in strength and the like can be achieved. When the filler is mixed, the content of the filler may be 0.3 mass percent or more and 30 mass percent or less when the hardened mold product is 100 mass percent, and the total content of the magnetic powder and the filler may be 20% by volume to 70% by volume when the hardened mold product is 100% by volume. When the filler is finer than the magnetic powder, the filler can be blended among the magnetic particles easier. Thus, the magnetic powder can be uniformly dispersed. Furthermore, a reduction in proportion of the magnetic powder because of the contained filler can be suppressed easier.

In particular, when injection molding is used, it is preferable to use, as the raw material, a mixture in which: average particle size of the magnetic powder is 1 μm or more and 200 μm or less, preferably 1 μm or more and 100 μm or less and whose circularity is 1.0 or more and 2.0 or less, preferably 1.0 or more and 1.5 or less; and the content of the magnetic powder of the divided pieces structuring the outer core portion is 30% by volume or more and 70% by volume or less, preferably 40% by volume or more and 60% by volume or less. In this situation, even when the divided pieces are each in a complicated shape, the mixture can be precisely packed in the mold assembly, and the divided pieces of high molding precision can be preferably molded. Further, using injection molding, voids can be reduced in number or can be reduced in size. Thus, deterioration of the magnetic characteristic attributed to a great number of voids or voids of great size can be suppressed. When the raw material containing the magnetic powder satisfying the conditions of the average particle size and circularity in the specific range noted above is used, the molding pressure in performing injection molding is suitably 10 MPa to 100 MPa.

Note that, with any of the molding schemes described above including the injection molding, deformation or reduction of the magnetic powder substantially does not occur during manufacture of the hardened mold product, and the shape, size and content of the magnetic powder used as the raw material can be retained. That is, the shape, size and content of the magnetic powder in the hardened mold product are substantially equal to those of the raw material.

The average particle size of the magnetic powder in the hardened mold product can be measured by, for example, removing resin components to extract the magnetic powder, and analyzing the grain size (particle size) of the obtained magnetic powder using a particle size analyzer. Any commercially available particle size analyzer can be used. When the hardened mold product contains the filler stated above, particles should be selected by performing a component analysis through the X-ray diffraction, the energy-dispersive X-ray spectroscopy (EDX) and the like. On the other hand, when the filler is made of a non-magnetic material, particles should be selected by a magnet.

The circularity is defined as: the maximum diameter of the particles structuring magnetic powder/equivalent circle diameter. The equivalent circle diameter is obtained by specifying the contour of each particle structuring the magnetic powder, to obtain the diameter of a circle having the area identical to area S enclosed by the contour. That is, the equivalent circle diameter is expressed as: 2×{area S in the contour/Π}1/2. Further, the maximum diameter is the maximum length of the particle having such a contour. Area S may be measured through the use of observation images of the cross section of the hardened mold product obtained by an optical microscope or a scanning electron microscope: SEM. Area S in the contour should be calculated by extracting the contour of the particle by subjecting the observation image of the obtained cross section to image processing (e.g., binarizing process) or the like. The maximum diameter may be measured by extracting the maximum length of the particle from the contour of the extracted particle. When an SEM is used, the measurement conditions may be as follows: the number of cross section is 50 pieces or more (one field of view per cross section); magnification is 50 times to 1000 times; the number of measured particles per field of view is 10 or more; and the number of particles in total is 1000 or more.

Herein, for the radially divided pieces 321 and 322, the magnetic powder being pure iron powder satisfying the average particle size being 54 μm and the circularity being 1.9 is employed. The content of the magnetic powder (pure iron powder) is 40% by volume and the binder resin is silicone resin. Further, the divided pieces 321 and 322 are each formed by injection molding.

Since the radially divided pieces 321 and 322 are each an independent member, the material, average particle size, circularity, and content of the magnetic powder structuring the divided pieces 321 and 322, the presence or absence, material, and content of the filler, the material of the binder resin and the like can be differed between the divided pieces 321 and 322. That is, the magnetic characteristic can be varied for each of the divided pieces 321 and 322. For example, when the content of the magnetic powder or the filler of the radially divided piece 322 disposed on the installation target side is greater than that of one radially divided piece 321, the heat dissipating characteristic can be enhanced. In particular, as shown in this example, with the horizontal disposition, a closed magnetic path can be fully formed even when the magnetic powder is unevenly located on the installation target side. Further, when the amount of the magnetic powder of one radially divided piece 321 is small, a reduction in weight of the outer core portion as a whole can be achieved.

Herein, the relative permeability of the outer core portion 32A is 5 to 30 and the saturation magnetic flux density of the outer core portion 32A is 0.5 T or more and less than the saturation magnetic flux density of the inner core portion 31. Further, in the outer core portion 32A, no gap members or air gaps are interposed. Since the relative permeability of the outer core portion 32A is lower than the inner core portion 31, the leakage flux of the magnetic core 3A can be reduced or the gapless structure magnetic core 3A can be obtained. For example, when the blending amount of the magnetic powder is reduced, a hardened mold product with low relative permeability can be obtained.

The saturation magnetic flux density or relative permeability of the inner core portion 31 and the outer core portion 32A can be measured by preparing the sample pieces of the core portions 31 and 32A, and using a commercially available B-H curve tracer or a VSM (Vibrating Sample Magnetometer).

[Other Structures]

<Resin Coat>

Though the reactor 1A can be used as it is, when the outer surface thereof is covered by resin, the mechanical protection or protection from the external environment for the outer core portion 32A can be achieved. As this resin, epoxy resin, silicone resin, unsaturated polyester, urethane resin, PPS resin, polybutylene terephthalate (PBT) resin, acrylonitrile butadiene styrene (ABS) resin and the like can be used. Similarly to the resin structuring the resin mold portion 20, when this resin also includes the filler described above, the heat dissipating characteristic, the strength and the like can be enhanced.

<Case>

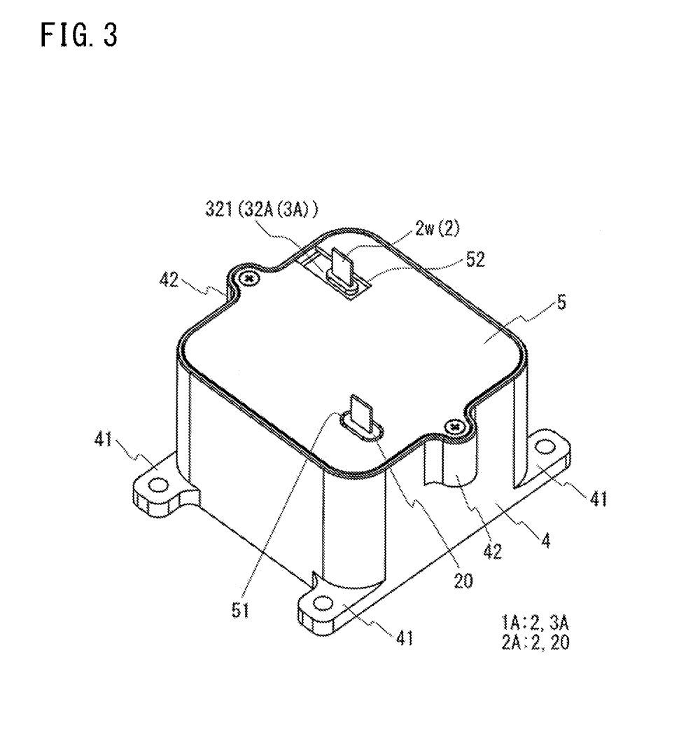

Alternatively, as shown in FIG. 3, the reactor 1A may be stored in a case 4. In this mode, by the case 4, mechanical protection or protection from the environment for the outer core portion 32A can be achieved. Using the case 4 made of a material that is lightweight and that exhibits excellent thermal conductivity, e.g., aluminum or alloy thereof, and magnesium or alloy thereof, a reactor being lightweight and exhibiting an excellent heat dissipating characteristic can be obtained. At this time, the case 4 is used as the heat dissipation path. Further, when the case 4 is made of a conductive material such as the metals noted above, the case 4 can block magnetism. Accordingly, any leakage flux to the outside of the case 4 can be effectively reduced.

The case 4 shown in this example is a bottomed square sleeve-like element conforming to the outer shape of the outer core portion 32A, and the bottom portion includes attaching portions 41 for fixing the case 4 to the installation target. The attaching portions 41 are provided to project outward from the outer circumferential face of the case 4, and each has a bolt hole through which a bolt (not shown) is inserted.

The inner circumferential face of the case 4 is in a flat shape conforming to the outer shape of the reactor 1A, and the outer surface of the outer core portion 32A is brought into contact therewith. Alternatively, for example, part of the coil mold product 2A may be exposed outside the outer core portion, and in the coil mold product 2A, this exposed portion may be brought into contact with the case 4. When the coil mold product 2A is directly brought into contact with the case 4, the resin structuring the resin mold portion 20 is interposed between the coil 2 and the case 4, and hence excellent insulating performance is exhibited. When the coil 2 is used as it is or when part of the coil 2 is not covered by the resin mold portion 20 but exposed, insulation can be enhanced by interposing an insulating member such as an insulating paper, an insulating sheet, an insulating tape, and an insulating adhesive agent between the coil 2 and the case 4. The smaller thickness of this insulating member (a total thickness when a multilayer structure is employed) can enhance the heat dissipating characteristic, so long as a prescribed insulating performance is secured, and the thickness may be less than 2 mm, further 1 mm or less, and particularly 0.5 mm or less.

In the mode in which the coil mold product 2A is in contact with the case 4, since the distance from the coil 2 to the case 4 becomes short, the heat dissipating characteristic can be enhanced. Further, when the outer surface of the reactor (the outer core portion) is in a concave-convex shape because of part of the coil mold product 2A being exposed, employing a mode in which a concave-convex portion conforming to this concave and convex is provided at the inner bottom face of the case, the contact area in the coil mold product relative to the case or the contact area in the outer core portion relative to the case can be increased, and thus the heat dissipating characteristic can be further enhanced. Further, this reactor can be positioned relative to the case easier.

When the coil mold product 2A is not exposed, at least part of the outer surface of the outer core portion 32A may be in a concave-convex shape (for example, provided with projections and holes), and a concave-convex portion conforming to this concave and convex may be provided to the inner circumferential face of the case 4. In this mode also, positioning of the reactor relative to the case 4 can be performed with ease.

In addition, the outer core portion 32A may be fixed to the case 4 by fixing members such as bolts. For example, the outer core portion 32A may be provided with bolt holes through which bolts are inserted or with which bolts are screwed. Alternatively, fastening portions with which bolts are screwed may be provided integrally with the outer core portion 32A. The fastening portions are preferably made of a material being greater in strength than the hardened mold product structuring the outer core portion 32A, for example, metal or the like.

In the mode where a lid 5, which will be described later, is included, when the lid 5 is positioned or fixed relative to the case 4 or the outer core portion 32A also, the aforementioned structures (the concave-convex portion, the bolt holes, and the fastening portions) can be employed.

The case 4 described above can be easily manufactured by casting or cutting work.

<Lid>

As shown in FIG. 3, further, the lid 5 closing the opening portion of the case 4 may be included. Similarly to the case 4, the lid 5 is also lightweight and exhibits excellent thermal conductivity. Structuring the lid 5 by a non-magnetic and conductive material, a reduction in weight, an improvement in the heat dissipating characteristic, and suppression of any leakage flux by blocking magnetism can be achieved. Further, when the lid 5 is fixed to the case 4, the reactor 1A can be preferably prevented from coming off. Here, the case 4 includes a bolt fastening portion 42 with which a bolt is screwed, and the lid 5 is fixed to the case 4 by the bolt. The position and number of pieces of the bolt fastening portion 42 are not particularly limited. As shown in FIG. 3, when the fastening target of the bolt is the case 4 made of metal, as compared to the situation where the outer core portion 32A is employed as the fastening target, troubles such as cracking occurring at the outer core portion 32A because of the fastening can be prevented. Alternatively, the lid 5 can be fixed to the case 4, the outer core portion 32A or the like by an adhesive agent.

The lid 5 is previously provided with a through hole 51 and a cutout 52 such that the end portions of the wire 2w structuring the coil 2 can be drawn out. Though FIG. 3 shows the mode in which the through hole 51 is provided for one end of the wire 2w and the cutout 52 is provided for other end thereof, the through holes 51 may be provided by two in number, or the cutouts 52 may be provided by two in number. Employing the through holes 51, the area of the outer core portion 32A exposed outside the lid 5 can be reduced easier. Employing the cutouts 52, the lid 5 can be attached easier.

In addition, a physical quantity measuring sensor (not shown) such as a temperature sensor and a current sensor can be included. When the lid is included in this mode, the lid is provided with a line-use hole (not shown) or a line-use cutout (not shown) for drawing out the line connected to the sensor.

<Sealing Resin>

When the case 4 is included, further, it is possible to employ a mode in which a sealing resin is packed between the reactor 1A and the case 4. The sealing resin may be any of a variety of resin noted in the foregoing section <Resin Coat>. Even in the mode where no lid 5 is included, the sealing resin can achieve mechanical protection and protection from the external environment for the outer core portion 32A (particularly the radially divided piece 321 disposed on the opening side of the case 4). Further, adhesion between the reactor 1A and the case 4 can be increased by the sealing resin. Alternatively, the reactor 1A can be fixed to the case 4 by an adhesive agent.

[Uses]

The reactor 1A structured as described above can be suitably used where the energizing conditions are, for example: the maximum current (direct current) is approximately 100 A to 1000 A; the average voltage is 100 V to 1000 V; and the working frequency is 5 kHz to 100 kHz. Representatively, the reactor 1A can be suitably used as a constituent component of an in-vehicle power converter apparatus for an electric vehicle, a hybrid vehicle, a fuel cell vehicle and the like.

[Method for Manufacturing Reactor]

The reactor 1A can be manufactured as follows, for example. Firstly, as shown in FIG. 2, the inner core portion 31 made of the coil 2 and the powder magnetic core are prepared. Then, the coil mold product 2A in which the coil 2 and the inner core portion 31 are integrally retained by the resin mold portion 20 as described above is produced. Further, by injection molding or the like, the radially divided pieces 321 and 322 structuring the outer core portion 32A are produced.

The coil mold product 2A is stored in the radially divided piece 322 disposed on the installation target side. Since the inner circumferential face 322i of the radially divided piece 322 conforms to the outer shape of the coil mold product 2A, the coil mold product 2A can be easily positioned, and furthermore, the coil mold product 2A can be retained.

From above the coil mold product 2A stored in the radially divided piece 322, one radially divided piece 321 having the wire holes 32h is disposed. At this time, the end portions of the wire 2w are inserted into the wire holes 32h. The divided pieces 321 and 322 can be precisely combined with each other employing the engaging portions (the engaging projections 33 (FIG. 1 (B)) and the engaging holes 34) as the guide. By assembling the coil mold product 2A and the radially divided pieces 321 and 322 to each other, the outer core portion 32A is formed. Further, the end faces of the coil mold product 2A are covered by part of the inner circumferential faces of the divided pieces 321 and 322, and the outer circumferential face of the coil mold product 2A is covered by other portion of the inner circumferential face of the divided pieces 321 and 322. That is, the end faces 31e of the inner core portion 31 are brought into contact with the inner circumferential faces of the divided pieces 321 and 322, and the magnetic core 3A is formed. Note that, the opposing faces 321f (FIG. 1 (C)) and 322f of the divided pieces 321 and 322 may be joined to each other by an adhesive agent. Further, solely one of the coil mold product 2A and the inner core portion 31 may be joined to the outer core portion 32A by an adhesive agent.

By the magnetic core 3A being formed, the reactor 1A is obtained. In the mode where the case 4 is included, the reactor 1A is stored in the case 4, and in the mode where the lid 5 is included, further the lid 5 is disposed.

[Effects]

With the reactor 1A, since the outer core portion 32A is a combination of a plurality of divided pieces, the manufacturing time per divided piece can be shortened. In particular, with the reactor 1A, since the divided pieces are each a mold product (a hardened mold product) of a mixture of magnetic powder and resin and manufactured through injection molding using a raw material of a particular specification, even the divided pieces of complicated shapes can be easily molded, and the manufacturing time of the divided pieces can be further reduced. Still further, with the reactor 1A, since the number of divided pieces is minimized, i.e., two, the time required for the combining work is also short. Thanks to these points, the reactor 1A exhibits excellent productivity. Further, the reactor 1A is expected to be suitable for mass production.

Furthermore, with the reactor 1A, the outer core portion 32A is structured by the radially divided pieces 321 and 322 in which the dividing direction is the radial direction of the coil 2. In particular, these divided pieces 321 and 322 are divided such that part of their seam portion, specifically the portion of the seam portion disposed on the end face side of the coil 2, is disposed in the radial direction of the coil 2, while other portion of the seam portion, specifically the portion disposed on the outer circumferential face side of the coil 2, is disposed in parallel to the axial direction of the coil 2. Accordingly, with the reactor 1A, gaps that break the magnetic flux do not occur between the divided pieces structuring the outer core portion 32A, and an excellent magnetic characteristic is also exhibited. Further, since the divided pieces 321 and 322 each have a Π-shaped cross section, the magnetic flux is allowed to pass from one end face side of the coil to the other end face side via the outer circumferential face side of the coil. This also contributes to an excellent magnetic characteristic.

Further, with the reactor 1A, since the divided pieces structuring the outer core portion 32A are each a hardened mold product, the following effects are also achieved: (1) the magnetic characteristic of the divided pieces can be easily changed; and (2) since the resin component is included, protection from the external environment and mechanical protection for the coil mold product 2A and the inner core portion 31 can be achieved. In addition, since the outer core portion 32A is made of a plurality of divided pieces, as compared to the situation where the outer core portion 32A is one hardened mold product, the divided pieces are small in size. Thus, the presence state (density) of the magnetic powder will not vary easily. Hence, a uniform magnetic characteristic can be obtained. Thanks to this point also, the reactor 1A exhibits an excellent magnetic characteristic.

In addition, since the reactor 1A employs the coil mold product 2A, the coil 2 can be easily handled, and hence excellent assemblability is exhibited. In particular, using the coil mold product 2A in which the inner core portion 31 is also integrally retained, the number of steps and components can be reduced, and further excellent assemblability is exhibited. Further, since the resin structuring the resin mold portion 20 is present between the coil 2 and the magnetic core 3A, the case 4 and the like, the reactor 1A also possesses an excellent insulating performance. In particular, with the reactor 1A, since the drawn out portions of the wire 2w structuring the coil 2 are also covered by the resin structuring the resin mold portion 20, insulation between the drawn out portions and the outer core portion 32A can be secured.

The reactor 1A is in the horizontal disposition whereby the distance between the coil 2 and the installation target when the reactor 1A is disposed on the installation target is small. Accordingly, the reactor 1A exhibits an excellent heat dissipating characteristic. In particular, with the reactor 1A, the region of the outer core portion 32A on the installation target side exhibits an excellent heat dissipating characteristic thanks also to its small thickness. Further, with the reactor 1A, the end face shape of the coil 2 is in a racetrack shape, that is, in the shape where the distance from the coil 2 to the installation target is short in many regions of the coil 2. Thanks also to this point, the reactor 1A exhibits an excellent heat dissipating characteristic.

Since the reactor 1A has one coil 2 and is in the horizontal disposition, it does not occupy a large space and is small in size. Further, the reactor 1A is small in size thanks also to the coil 2 being an edgewise coil whose space factor is great and whose size can be easily reduced. Further, since the saturation magnetic flux density of the inner core portion 31 is higher than that of the outer core portion 32A, in obtaining the magnetic flux identical to that produced by a magnetic core made of a single material and the saturation magnetic flux density as a whole is uniform, the cross-sectional area (the plane where the magnetic flux passes) of the inner core portion 31 can be made small. Thanks to this point also, the reactor 1A is small in size. Additionally, with the reactor 1A, the size is reduced also by elimination of any gap. Furthermore, any loss attributed to the gap can be reduced.

With the reactor 1A, since the inner core portion 31 is a powder magnetic core, the following effects are also achieved: (1) even a complicated three-dimensional shape can be formed with ease, and hence excellent productivity is achieved; and (2) the magnetic characteristic such as a saturation magnetic flux density can be adjusted with ease.

### Second Embodiment

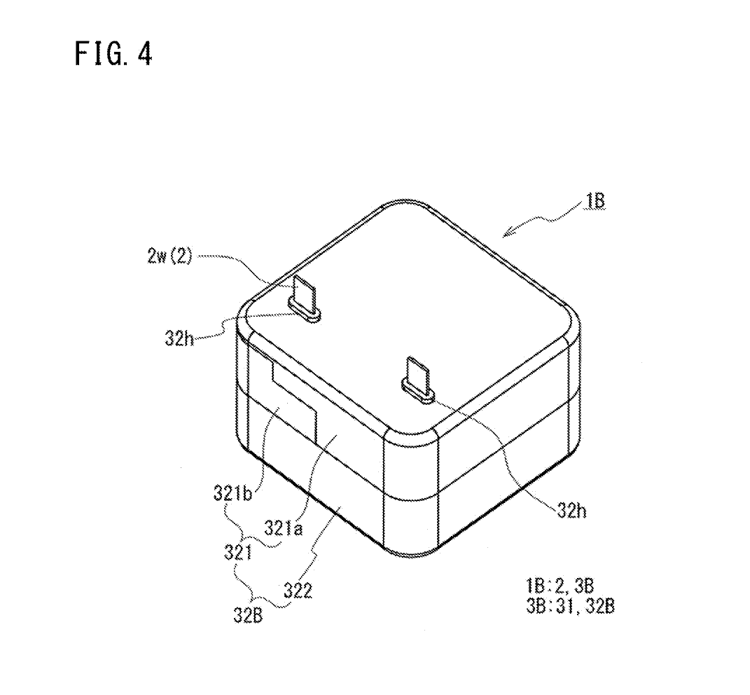

In the following, with reference to FIGS. 4 to 6, a description will be given of a reactor 1B according to the second embodiment. The basic structure of the reactor 1B is similar to the reactor 1A according to the first embodiment. The main differences from the first embodiment lie in that, out of the two radially divided pieces 321 and 322 structuring an outer core portion 32B, one radially divided piece 321 is further divided, and that one end portion of the wire 2w structuring the coil 2 is disposed at a different place. In the following, a description will be given focusing on the differences, and the detailed description as to the structure and effects being similar to those of the first embodiment will not be given.

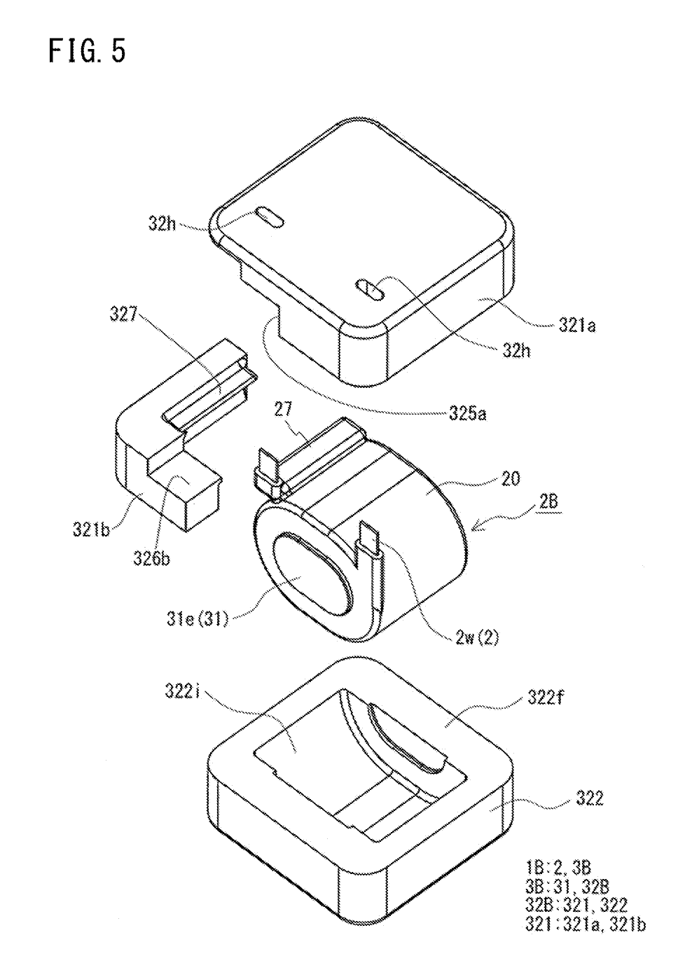

With the coil 2 according to the first embodiment, the end portions of the wire 2w are different from each other in the disposition position in the axial direction of the coil, and the end portions are respectively disposed on the end face sides of the coil 2. With the coil 2 according to the second embodiment, one end portion of the wire 2w is folded back toward other end portion. The opposite end portions of the wire 2w are equal to each other in the disposition position in the axial direction of the coil, and the opposite end portions are juxtaposed to each other at around one end face of the coil 2. This folded back portion projects further than the turn forming face of the coil 2. Accordingly, the coil mold product 2B included in the reactor 1B according to the second embodiment is provided with, as shown in FIG. 5, an overhanging portion 27 in which the portion projecting from the turn forming face of the coil 2 is covered by the resin structuring the resin mold portion 20.

As shown in FIG. 4, the outer core portion 32B included in the reactor 1B is a solid whose outer shape is a rectangular parallelepiped-shape similarly to the reactor 1A according to the first embodiment. The outer core portion 32B includes halved pieces divided in the radial direction of the coil 2, i.e., the radially divided pieces 321 and 322. Note that, the radially divided piece 321 including the wire holes 32h through which the end portions of the wire 2w of the coil 2 are drawn out is structured by a combination of a Π-shaped piece 321a whose cross section is Π-shaped and an L-shaped piece 321b whose outer shape is L-shaped, as shown in FIG. 5. That is, the magnetic core 3B included in the reactor 1B includes the inner core portion 31 and the outer core portion 32B structured by the three divided pieces.

The Π-shaped piece 321a has a shape obtained by cutting out an L-shaped portion including one corner from the side wall provided upright at the bottom face (the face disposed at the top in FIGS. 4 and 5) in one radially divided piece 321 included in the reactor 1A according to the first embodiment. The L-shaped piece 321b forms this cut out portion. The Π-shaped piece 321a and other radially divided piece 322 include the portions covering part of (herein, half) the end faces of the coil 2 and the portion covering part (herein, half the circumference) of the outer circumferential face of the coil 2.

As shown in FIG. 5, the L-shaped piece 321b includes a wire-use projecting portion 327 where the overhanging portion 27 of the coil mold product 2B is disposed. Thanks to the wire-use projecting portion 327, the magnetic component (the outer core portion 32B) can exist below the overhanging portion 27 also, and substantially the entire outer surface of the coil mold product 2B can be covered by the outer core portion 32B. Further, since the radially divided piece 321 is divided into the Π-shaped piece 321a and the L-shaped piece 321b, the wire-use projecting portion 327 can be easily disposed below the overhanging portion 27.

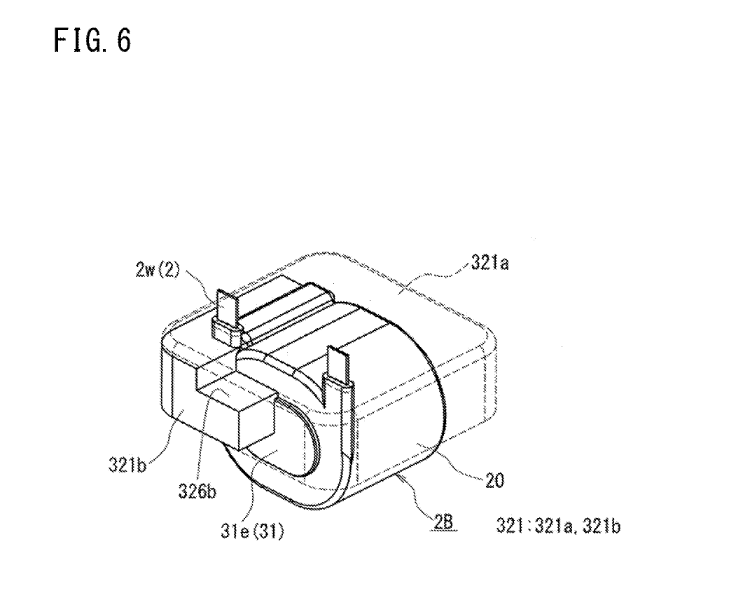

Herein, as shown in FIG. 6, the contact faces between the Π-shaped piece 321a and the L-shaped piece 321b are provided in a stepwise manner. These stepwise faces, i.e., engaging step portion 325a (FIG. 5) and 326b, function as the engaging portions of the pieces 321a and 321b, and the pieces 321a and 321b can be easily positioned. When the pieces 321a and 321b are combined with each other, part of the seam portion, specifically the portion disposed on the end face side of the coil 2, becomes stepwise by the engaging step portions 325a and 326b as shown in FIG. 4. The shape of the engaging portions can be selected as appropriate. For example, the engaging projections 33 and the engaging holes 34 according to the first embodiment described above can be used. As in this example, when the engaging portions are formed by flat surfaces, the shape of the divided pieces can be simplified, and hence excellent moldability is achieved. Alternatively, no engaging portions may be included.

The reactor 1B according to the second embodiment is assembled as follows. Similarly to the first embodiment, the coil mold product 2B is fitted to the radially divided piece 322 (see FIG. 5). Next, the L-shaped piece 321b is assembled thereto (see FIG. 6). The L-shaped piece 321b is hooked on the coil mold product 2B, and held by the opposing face 322f of the radially divided piece 322. Next, similarly to the first embodiment, from above the coil mold product 2B, the Π-shaped piece 321a is disposed, and the opposite end portions of the wire 2w are inserted into the wire holes 32h (see FIG. 4).

With the reactor 1B according to the second embodiment, in the seam portion of the Π-shaped piece 321a and the L-shaped piece 321b structuring the radially divided piece 321, the portion disposed on the outer circumferential face side of the coil 2 is present to break the magnetic flux. However, similarly to the first embodiment, other radially divided piece 322 substantially does not break the magnetic flux. Further, the seam portion formed by the divided pieces 321 and 322 substantially does not break the magnetic flux, similarly to the first embodiment. Accordingly, the reactor 1B according to the second embodiment involves only a small number of gaps among the divided pieces structuring the outer core portion 32B that break the magnetic flux, and hence an excellent magnetic characteristic is exhibited.

### Third Embodiment

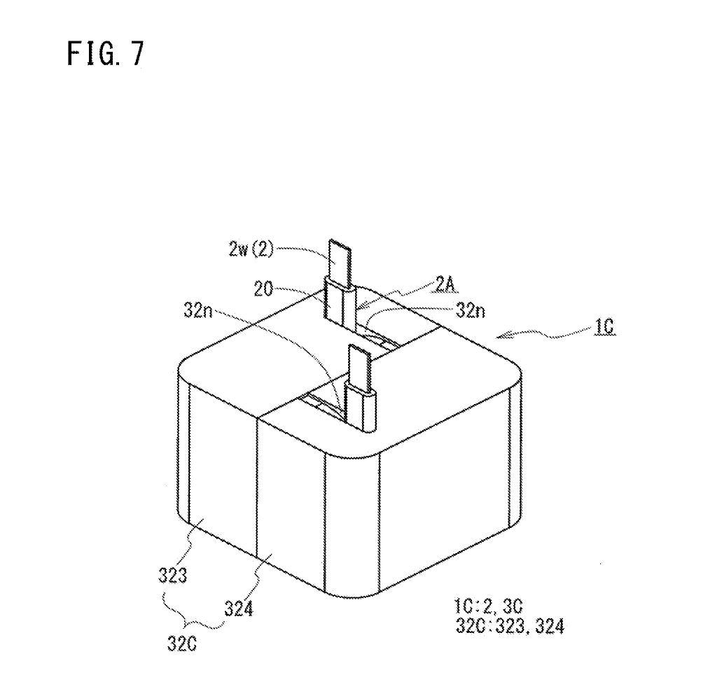

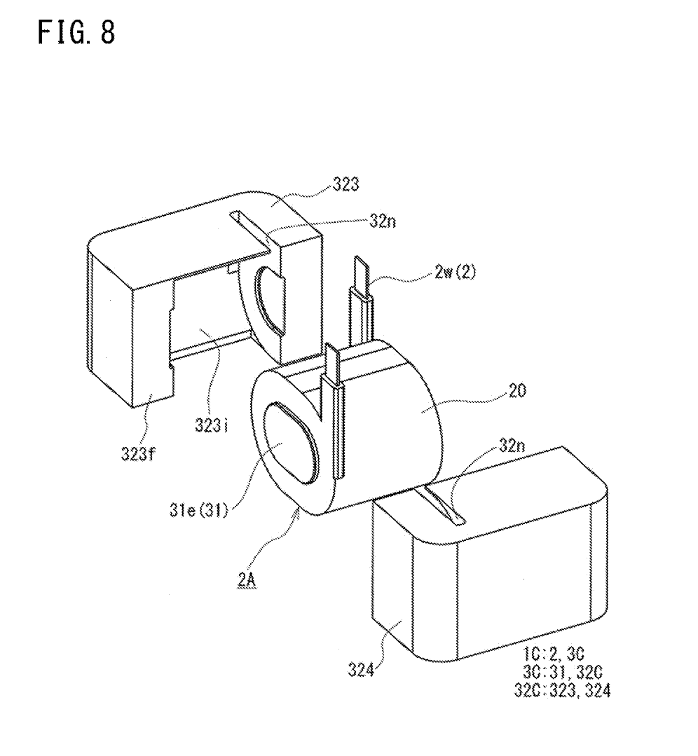

In the following, with reference to FIGS. 7 and 8, a description will be given of a reactor 1C according to a third embodiment. The basic structure of the reactor 1C is similar to the reactor 1A according to the first embodiment. The main difference lies in the shape of radially divided pieces 323 and 324 included in an outer core portion 32C. In the following, a description will be given focusing on the differences, and the detailed description as to the structure and effects being similar to those of the first embodiment will not be given.

As shown in FIG. 7, the outer core portion 32C included in the reactor 1C according to the third embodiment is also a solid whose outer shape is rectangular parallelepiped-shaped and which is structured by halved pieces obtained by cutting the solid along a plane passing through the axis of the coil 2, i.e., the radially divided pieces 323 and 324. That is, the magnetic core 3C included in the reactor 1C includes the inner core portion 31 and the outer core portion 32C made up of two divided pieces 323 and 324. Note that, both the divided pieces 323 and 324 according to the third embodiment are brought into contact with the installation target, and they separate in the direction parallel to the surface of the installation target.

As shown in FIG. 8, the inner circumferential faces of the radially divided pieces 323 and 324 are formed in the shape conforming to the outer shape of the coil mold product 2A stored therein, similarly to the first embodiment (FIG. 8 shows only an inner circumferential face 323i of one radially divided piece 323). The divided pieces 323 and 324 each include the portions covering part of (herein, half) the end faces of the coil mold product 2A and the portion covering part (herein, less than half the circumference) of the outer circumferential face of the coil mold product 2A.

The opposing faces of the radially divided pieces 323 and 324 being in contact with each other (FIG. 8 shows only an opposing face 323f of one radially divided piece 323) are flat surfaces, and the seam portion of the divided pieces 323 and 324 is formed by a straight line, as shown in FIG. 7. Similarly to the reactor 1A according to the first embodiment, since the straight line forming the seam portion becomes a straight line being present on the plane passing through the axis of the coil 2 (the straight line being parallel to the axial direction of the coil 2 and the straight line being parallel to the radial direction of the coil 2), it substantially does not break the magnetic flux. Further, the seam portion includes a region disposed perpendicularly to the surface of the installation target and a region disposed in parallel thereto, when the reactor 1C is disposed on the installation target.

According to the third embodiment, in the outer circumferential face of the coil mold product 2A, the region on the installation target side is not covered by the outer core portion 32C but exposed. Accordingly, the installed side face of the reactor 1C according to the third embodiment is formed by part of the outer surface of the radially divided pieces 323 and 324 structuring the outer core portion 32C, and part of the outer circumferential face of the coil mold product 2A. It is also possible that the outer core portion covers the entire outer surface of the coil mold product, as in the first and second embodiments.

Since the outer circumferential face of the coil mold product 2A is partially exposed as described above, the vertical cross section thereof taken along a plane being parallel to the opposing faces of the radially divided pieces 323 and 324 and the axial direction of the coil 2 is Π-shaped, as shown in FIG. 8. Further, the horizontal cross section (not shown) of the divided pieces 323 and 324 taken along a plane being perpendicular to the axial direction of the coil 2 is L-shaped.

Though the radially divided pieces 323 and 324 according to the third embodiment do not have engaging portions, they may have engaging portions as described in connection with the first embodiment.

The radially divided pieces 323 and 324 according to the third embodiment each have a wire cutout 32n into which each end portion of the wire 2w of the coil 2 is fitted. The shape and size of the wire cutouts 32n are adjusted such that the end portions of the wire 2w can be inserted into the portions corresponding to the disposition positions of the end portions of the wire 2w at the divided pieces 323 and 324. When the divided pieces 323 and 324 are assembled to the coil mold product 2A, the drawn out portions of the wire 2w are inserted from the opening portions of the wire cutouts 32n provided at the opposing faces of the divided pieces 323 and 324. At this time, the wire cutouts 32n function also as the guide. After the coil mold product 2A and the divided pieces 323 and 324 are assembled to each other, the opening portions of the wire cutouts 32n may be buried by a mixture of magnetic powder and resin being the constituent material of the divided pieces 323 and 324. Thus, the coil mold product 2A is not exposed outside the opening portions, and furthermore, the magnetic path area can be increased.

In the reactor 1C according to the third embodiment also, gaps that break the magnetic flux substantially do not exist among the divided pieces structuring the outer core portion 32C. Hence, an excellent magnetic characteristic is also exhibited.

(Variation 1)

In the first to third embodiments, two radially divided pieces are included. However, three radially divided pieces may be included. In this mode, two radially divided pieces each having a Π-shaped cross section as in the first embodiment, and a frame-like piece interposed between these radially divided pieces with the Π-shaped cross section (for example, a rectangular frame-like piece) are included. Alternatively, the radially divided piece having the shape identical to that in the third embodiment may be included by two in number and a Π-shaped frame piece interposed between these radially divided pieces is included. In this manner, increasing the number of pieces of the radially divided pieces, the divided pieces are each reduced in size. Therefore, even when cast molding is used, the manufacturing time can be shortened. Further, when the number of pieces is great, the magnetic characteristic of the divided pieces can be varied stepwise.

(Variation 2)

In the first to third embodiments, in the seam portion of the radially divided pieces, the portion disposed on the end face side of the coil is disposed along the major axis (the first and second embodiments) or along the minor axis (the third embodiment). However, it can be disposed along the radial direction other than the major axis and the minor axis. In this mode, part of the seam portion, specifically the portion disposed on the end face side of the coil, is disposed in the radial direction (other than the major axis and the minor axis) of the coil, and other portion of the seam portion, specifically the portion disposed on the outer circumferential face of the coil, is disposed in parallel to the axial direction of the coil similarly to the first to third embodiments. Thus, gaps that break the magnetic flux substantially do not occur in the outer core portion. When the reactor is disposed on the installation target, part of the seam portion is disposed to cross the surface of the installation target, while other part of the seam portion is disposed in parallel to the surface of the installation target.

(Variation 3)

In the first to third embodiments, the horizontal disposition is employed, in which the axial direction of the coil 2 is parallel to the surface of the installation target. However, it is also possible to employ the mode as described in Patent Literature 2, in which the coil is disposed such that the axial direction of the coil is perpendicular to the surface of the installation target (hereinafter referred to as the vertical disposition). The vertical disposition can reduce the installation area. When the vertical disposition is employed also, the end face of the coil 2 or that of the coil mold product, or the region on one end face side of the inner core portion 31 can be exposed outside the outer core portion.

(Variation 4)

According to the first to third embodiments, the coil mold products 2A and 2B are included. However, the coil 2 can be used as it is. Alternatively, for example, applying an insulating tape or disposing an insulating paper or an insulating sheet at the outer surface of the coil 2 and the inner core portion 31, an insulating member can be interposed between the coil 2 and the magnetic cores 3A and 3B. Alternatively, when an insulator made of an insulating material being identical to the constituent material structuring the bobbins 21 is provided at the outer circumference of the inner core portion 31, insulation between the coil 2 and the inner core portion 31 can be enhanced. The insulator may be a sleeve-like element covering the outer circumference of the inner core portion 31, or may include the sleeve-like element and a flange portion (e.g., an annular piece) projecting toward the outside from each of the opposite edge portions of the sleeve-like element. When the sleeve-like element is a divided piece that can be divided in the radial direction of the coil 2, it can be easily disposed on the outer circumference of the inner core portion 31. Further, the sleeve-like element can be used for positioning the inner core portion 31 with respect to the coil 2.

(Variation 5)

According to the first to third embodiments, one sleeve-like coil is included. However, a pair of coil elements can be included. What are included in this mode are: a coil including a pair of sleeve-like coil elements juxtaposed to each other such that their respective axes are paralleled; and a magnetic core having a pair of inner core portions disposed inside the coil elements and outer core portions disposed outside the coil elements. The magnetic core is structured in an annular shape, by the outer core portions being connected so as to connect between the juxtaposed inner core portions. In this mode, for example, similarly to the first to third embodiments, the outer core portion can be structured by a combination of a pair of divided pieces with a Π-shaped cross section. Similarly to the first to third embodiments, the divided pieces with the Π-shaped cross section are structured to be disposed on the end face side and outer circumferential face side of the coil, and separated in the radial direction of the coil element. Alternatively, for example, the outer core portion may be a combination of a plurality of divided pieces each being a rectangular parallelepiped-shaped columnar element or the like. The columnar divided pieces are disposed such that the juxtaposed inner core portions are interposed therebetween. That is, the columnar divided pieces are disposed on the end face sides of the coil element, and disposed so as to form a closed magnetic path as being connected to the inner core portions. Then, the columnar divided pieces are each structured to be separated in the radial direction of the coil element. In any of the mode, the material of the outer core portion can be partially varied, as described above.

### Embodiment I

The reactor according to any of the first to third embodiments and Variations 1 to 5 may be used, for example, as a constituent component of a converter mounted on a vehicle or the like, or as a constituent component of a power converter apparatus including the converter.

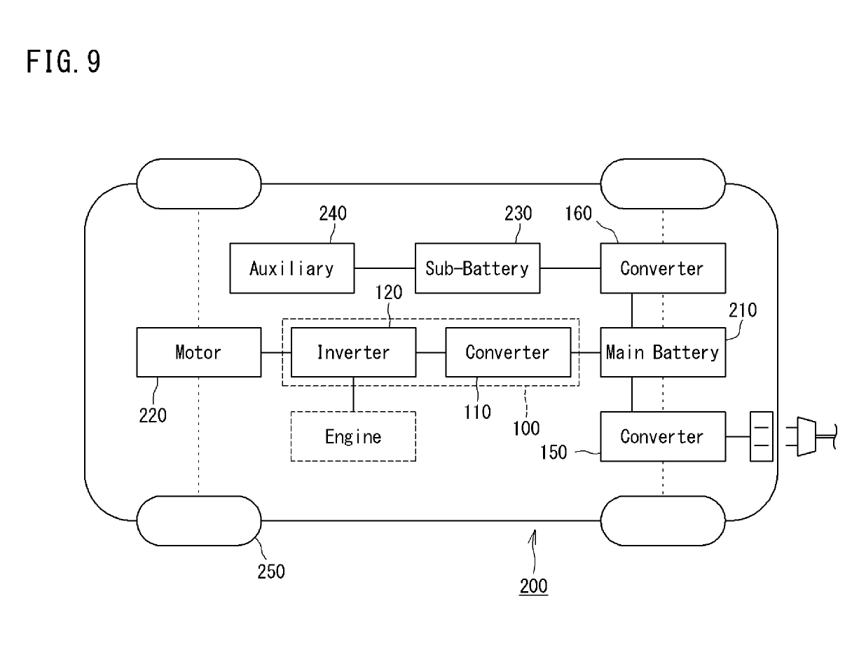

For example, as shown in FIG. 9, a vehicle 200 such as a hybrid vehicle or an electric vehicle includes a main battery 210, a power converter apparatus 100 connected to the main battery 210, and a motor (load) 220 driven by power supplied from the main battery 210 and serves for traveling. The motor 220 is representatively a three-phase alternating current motor. The motor 220 drives wheels 250 in the traveling mode and functions as a generator in the regenerative mode. When the vehicle is a hybrid vehicle, the vehicle 200 includes an engine in addition to the motor 220. Though an inlet is shown as a charging portion of the vehicle 200 in FIG. 9, a plug may be included.

The power converter apparatus 100 includes a converter 110 connected to the main battery 210 and an inverter 120 connected to the converter 110 to perform interconversion between direct current and alternating current. When the vehicle 200 is in the traveling mode, the converter 110 in this example steps up DC voltage (input voltage) of approximately 200 V to 300 V of the main battery 210 to approximately 400 V to 700 V, and supplies the inverter 120 with the stepped up power. Further, in the regenerative mode, the converter 110 steps down DC voltage (input voltage) output from the motor 220 through the inverter 120 to DC voltage suitable for the main battery 210, such that the main battery 210 is charged with the DC voltage. When the vehicle 200 is in the traveling mode, the inverter 120 converts the direct current stepped up by the converter 110 to a prescribed alternating current and supplies the motor 220 with the alternating current. In the regenerative mode, the inverter 120 converts the AC output from the motor 220 into direct current, and outputs the direct current to the converter 110.

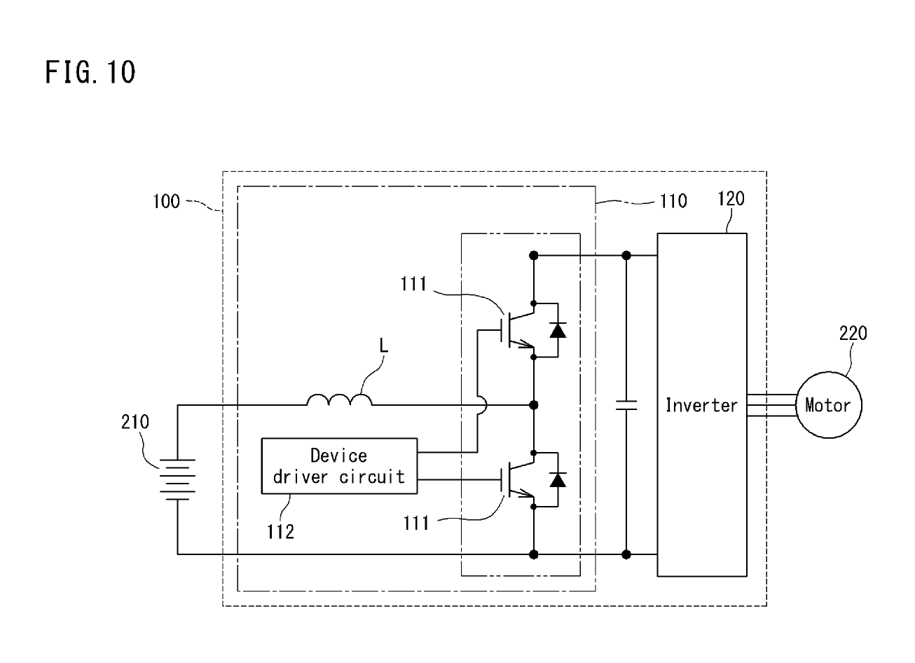

As shown in FIG. 10, the converter 110 includes a plurality of switching elements 111, a driver circuit 112 that controls operations of the switching elements 111, and a reactor L. The converter 110 converts (here, performs step up and down) the input voltage by repetitively performing ON/OFF (switching operations). As the switching elements 111, power devices such as FETs and IGBTs are used. The reactor L uses a characteristic of a coil that disturbs a change of current which flows through the circuit, and hence has a function of making the change smooth when the current is increased or decreased by the switching operation. The reactor L is the reactor according to any of the first to third embodiments and Variations 1 to 5. Since the reactor with excellent productivity is included, the power converter apparatus 100 and the converter 110 exhibit excellent productivity.

The vehicle 200 includes, in addition to the converter 110, a power supply apparatus-use converter 150 connected to the main battery 210, and an auxiliary power supply-use converter 160 connected to a sub-battery 230 serving as a power supply of auxiliary equipment 240 and to the main battery 210, to convert a high voltage of the main battery 210 to a low voltage. The converter 110 representatively performs DC-DC conversion, whereas the power supply apparatus-use converter 150 and the auxiliary power supply-use converter 160 perform AC-DC conversion. Some types of the power supply apparatus-use converter 150 perform DC-DC conversion. The power supply apparatus-use converter 150 and the auxiliary power supply-use converter 160 each may be structured similarly to the reactor according the first to third embodiments and Variations 1 to 5, and the size and shape of the reactor may be changed as appropriate. Further, the reactor according to any of the foregoing first to third embodiments and Variations 1 to 5 may be used as a converter that performs conversion for the input power and that performs only stepping up or stepping down.

Note that the present invention is not limited to the embodiments described above, and can be practiced as being modified as appropriate within a range not departing from the gist of the present invention.

### INDUSTRIAL APPLICABILITY

The reactor of the present invention can be suitably used as any of various types of reactors (an in-vehicle component, a component of power generating plants and substation facilities and the like). In particular, the reactor of the present invention can be used as a constituent component of a power converter apparatus, such as a DC-DC converter mounted on a vehicle such as a hybrid vehicle, an electric vehicle, a fuel cell vehicle and the like. The converter of the present invention and the power converter apparatus of the present invention can be used in various fields, such as in-vehicle devices, power generating plants and substation facilities.

### REFERENCE SIGNS LIST

1A, 1B, 1C: REACTOR
2A, 2B: COIL MOLD PRODUCT
2: COIL
2w: WIRE
20: RESIN MOLD PORTION
21: BOBBIN
27: OVERHANGING PORTION
3A, 3B, 3C: MAGNETIC CORE
31: INNER CORE PORTION
31e: END FACE
32A, 32B, 32C: OUTER CORE PORTION
321, 322, 323, 324: RADIALLY DIVIDED PIECE
321a: Π-SHAPED PIECE
321b: L-SHAPED PIECE
321f, 322f, 323f: OPPOSING FACE
322i, 323i: INNER CIRCUMFERENTIAL FACE
325a, 326b: ENGAGING STEP PORTION
327: WIRE-USE PROJECTING PORTION
32h: WIRE HOLE
32n: WIRE CUTOUT
33: ENGAGING PROJECTION
34: ENGAGING HOLE
4: CASE
41: ATTACHING PORTION
42: BOLT FASTENING PORTION
5: LID
51: THROUGH HOLE
52: CUTOUT
100: POWER CONVERTER APPARATUS
110: CONVERTER
111: SWITCHING ELEMENT
112: DRIVER CIRCUIT
120: INVERTER
150: POWER SUPPLY APPARATUS-USE CONVERTER
160: AUXILIARY POWER SUPPLY-USE CONVERTER
200: VEHICLE
210: MAN BATTERY
220: MOTOR
230: SUB-BATTERY
240: AUXILIARY EQUIPMENT
250: WHEELS

1. A reactor comprising:
a sleeve-like coil; and
a magnetic core that has an inner core portion disposed inside the coil and an outer core portion disposed outside the coil, the outer core portion forming a closed magnetic path with the inner core portion, wherein
the outer core portion is structured by a combination of a plurality of divided pieces each being a mold product of a mixture of magnetic powder and resin, and
the outer core portion includes at least two radially divided pieces that can be separated in a radial direction of the coil.

2. The reactor according to claim 1, wherein
an average particle size of the magnetic powder is 1 μm or more and 200 μm or less,
a circularity of the magnetic powder is 1.0 or more and 2.0 or less, and
a content of the magnetic powder in the divided pieces is 30% by volume or more and 70% by volume or less.

3. The reactor according to claim 1, wherein
the sleeve-like coil is included by one in number, and
at least one of the radially divided pieces includes portions that respectively partially cover end faces of the coil, and a portion that partially covers an outer circumferential face of the coil.

4. The reactor according to claim 1, wherein
the divided pieces respectively have engaging portions that engage with each other.

5. A converter comprising:
a switching element;
a driver circuit that controls an operation of the switching element; and
a reactor that smoothes a switching operation, wherein
the converter converts an input voltage by the operation of the switching element, and
the reactor is the reactor according to claim 1.

6. A power converter apparatus comprising:
a converter that converts an input voltage; and
an inverter that is connected to the converter and that performs interconversion between a direct current and an alternating current, wherein
the power converter apparatus drives a load by power obtained by conversion of the inverter, and
the converter is the converter according to claim 5.
